(19) United States
(12) Patent Application Publication
(10) Pub. No.: US 2013/0236024 A1
(43) Pub. Date: Sep. 12, 2013

(54) SOUND QUALITY TESTING DEVICE

(71) Applicants: CHUN-WEI KAO, TAIPEI CITY (TW); LIANG-CHI HOU, NEW TAIPEI CITY (TW); HSIU-PING YANG, TAIPEI CITY (TW); CHING-FENG HSIEH, TAIPEI CITY (TW)

(72) Inventors: CHUN-WEI KAO, TAIPEI CITY (TW); LIANG-CHI HOU, NEW TAIPEI CITY (TW); HSIU-PING YANG, TAIPEI CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/454,617

(22) Filed: Apr. 24, 2012

(30) Foreign Application Priority Data
Mar. 6, 2012 (TW) 101107498

(51) Int. Cl. H04R 29/00

(52) U.S. Cl. 381/59

(57) ABSTRACT

A sound quality testing device for testing a communication apparatus has a sound generating unit and a sound receiving unit. The sound quality testing device includes a carrying unit, a first testing module, and a second testing module. The carrying unit carries the communication apparatus. The first testing module generates and sends a sound signal to the sound receiving unit. The second testing module receives a sound-generating signal generated by the sound generating unit. The sound quality testing device provides a standardized simulation testing environment having low or no noise signals, such that the communication apparatus can be tested precisely and steadily in terms of sound quality, such as volume, frequency responses, and harmonic wave distortion.

### CROSS-REFERENCE TO RELATED APPLICATION

This non-provisional application claims priority under 35 U.S.C. §119(a) on Patent Application No(s).101107498 filed in Taiwan, R.O.C. on Mar. 6, 2012, the entire contents of which are hereby incorporated by reference.

### FIELD OF TECHNOLOGY

The present invention relates to sound quality testing devices, and more particularly, to a sound quality testing device for testing the sound quality of a communication apparatus having a loudspeaker and a microphone.

### BACKGROUND

After the manufacturing process of a conventional communication apparatus, such as a handheld electronic device, a Voice over Internet Protocol (VoIP), or a public switched telephone network (PSTN) phone, has been finished at the production end, a test is performed on the conventional communication apparatus to evaluate the sound receiving and generating functions thereof.

In general, a sound guiding tube is installed on the communication apparatus. One end of the sound guiding tube is in contact with and thus is disposed at a loudspeaker installed on the communication apparatus. Likewise, the other end of the sound guiding tube is in contact with and thus is disposed at a microphone installed on the communication apparatus. Hence, the sound generated by the loudspeaker is transmitted to the microphone through the sound guiding tube so as to form a testing loop for assessing the performance and quality of the communication apparatus in terms of the sound receiving and generating functions thereof.

However, the aforesaid conventional testing method can only confirm whether the microphone and the loudspeaker are functioning, but cannot test the sound quality, such as volume, frequency responses, and harmonic wave distortion, of the microphone and the loudspeaker. As a result, the conventional testing method only performs a rough test on the communication apparatus but is not efficient in performing quality control over sound receiving and generating quality.

In addition, in the situation where every communication apparatus is tested with the aforesaid conventional testing method, it is possible that the sound guiding tube is located at different positions and thus produces test errors, thereby compromising the stability of test quality. Furthermore, to reduce test errors, it is necessary to take a relatively long period of time to calibrate the sound guiding tube with a view to attaining a precise test result.

Accordingly, the present invention provides a test device that is effective in overcoming the aforesaid drawbacks of the prior art, enabling quick test, and boosting test stability.

### SUMMARY

It is an objective of the present invention to provide a sound quality testing device for testing the sound quality of a communication apparatus.

Another objective of the present invention is to provide the sound quality testing device for testing a loudspeaker or a microphone of a communication apparatus accurately and steadily.

In order to achieve the above and other objectives, the present invention provides a sound quality testing device for testing a communication apparatus having a sound generating unit and a sound receiving unit, comprising a carrying unit, a first testing module, and a second testing module. The carrying unit carries the communication apparatus. The first testing module is disposed at the carrying unit and has a sound source unit and a first adjusting unit. The sound source unit generates a sound signal. The first adjusting unit adjusts a position of the sound source unit based on a position of the sound receiving unit of the communication apparatus. The second testing module is disposed at the carrying unit and has a receiving unit and a second adjusting unit. The receiving unit receives a sound-generating signal from the sound generating unit. The second adjusting unit adjusts a position of the receiving unit based on a position of the sound generating unit of the communication apparatus.

Compared with the prior art, the present invention provides a sound quality testing device whereby a sound signal is generated from a first testing module thereof and sent to a sound receiving unit (such as a microphone) of a communication apparatus. After receiving the sound signal, the sound receiving unit evaluates the sound quality related to the sound signal, such as volume, frequency responses, and harmonic wave distortion. A sound-generating signal generated from a sound generating unit of the communication apparatus (such as a sound-generating signal generated from a loudspeaker of the communication apparatus) is received by a second testing module. After receiving the sound-generating signal, the second testing module evaluates the sound quality of the sound signal generated from the sound generating unit. Hence, the present invention involves using at least two testing modules to simulate an environment in which users operate the communication apparatus and using the first testing module and the second testing module to evaluate the sound quality related to the communication apparatus precisely and quickly.

### BRIEF DESCRIPTION

Objectives, features, and advantages of the present invention are hereunder illustrated with specific embodiments in conjunction with the accompanying drawings, in which:

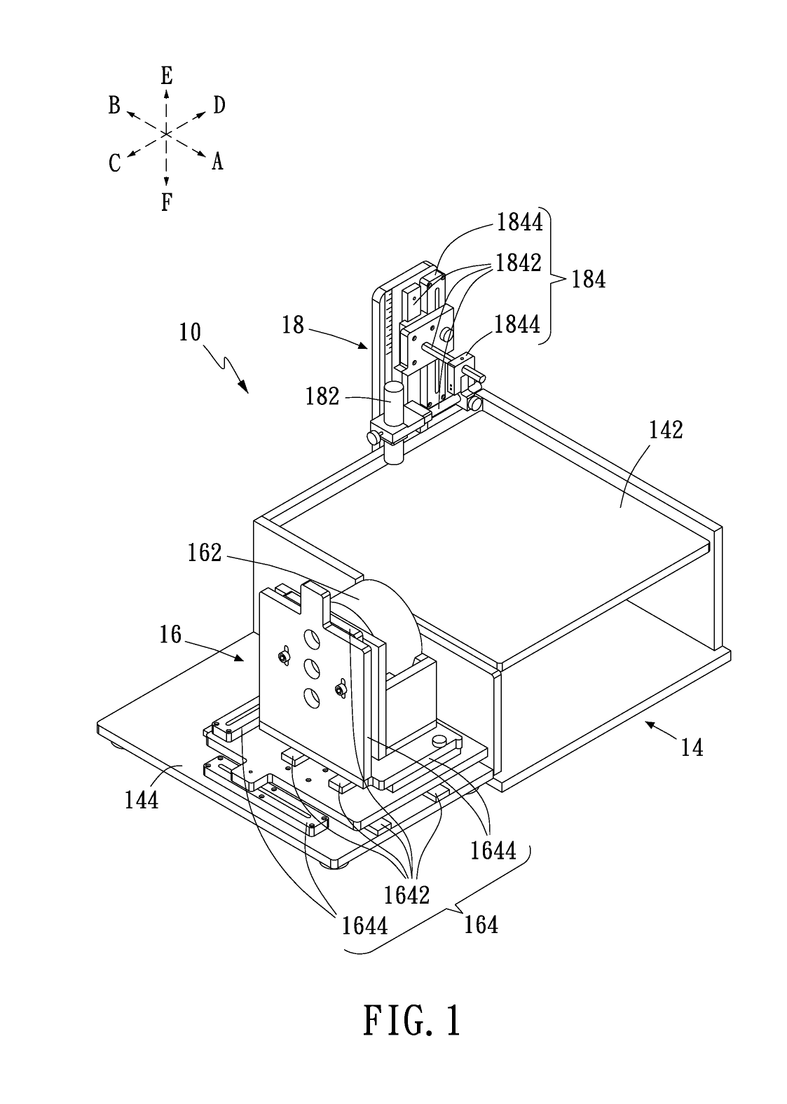

FIG. 1 is a schematic view of a sound quality testing device according to the first embodiment of the present invention;

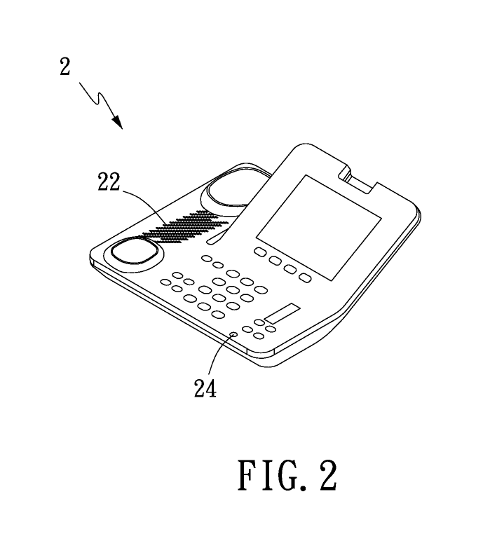

FIG. 2 is a schematic view of a communication apparatus shown in FIG. 1;

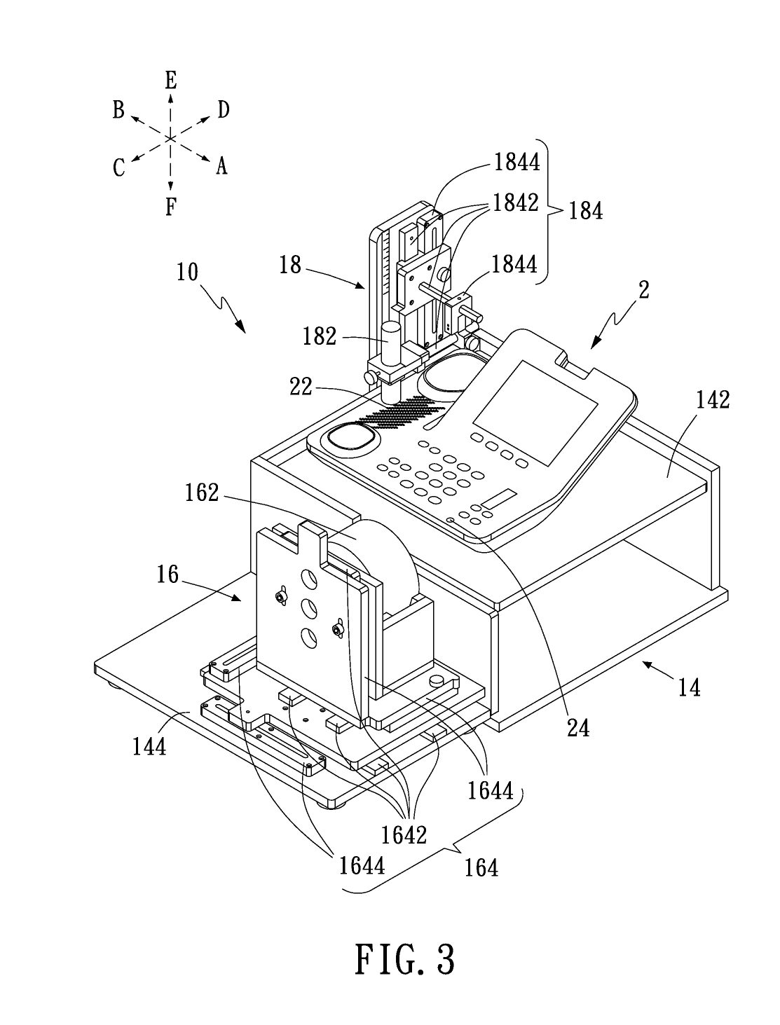

FIG. 3 is a schematic view of the sound quality testing device and the communication apparatus coupled together as shown in FIG. 1;

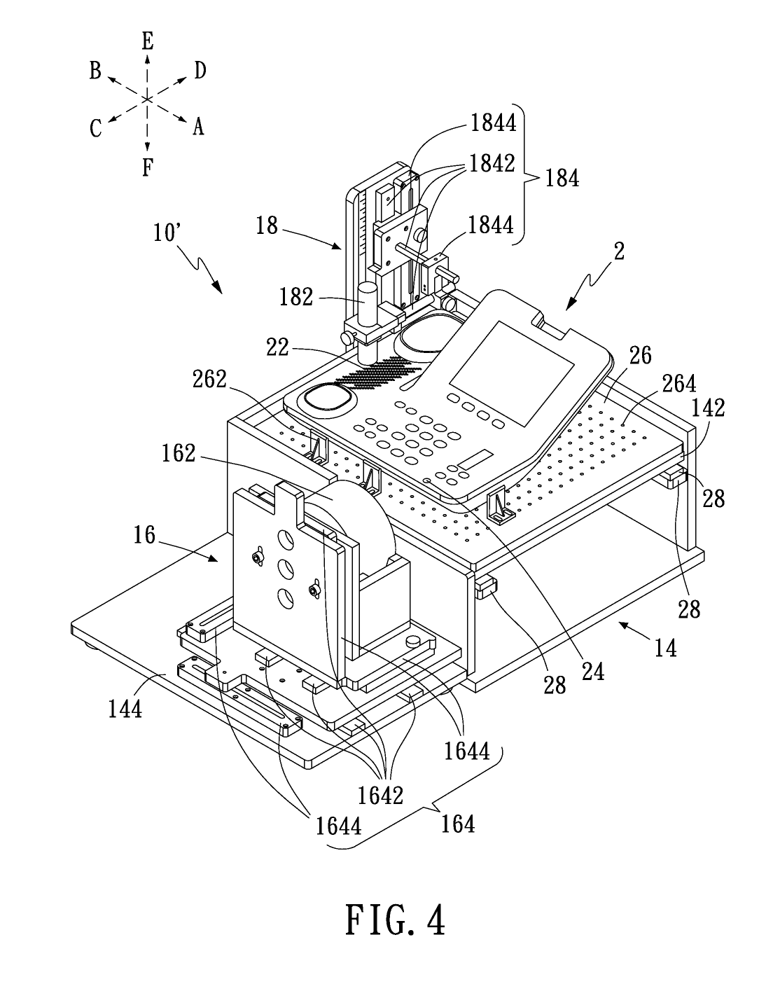

FIG. 4 is a schematic view of the sound quality testing device according to the second embodiment of the present invention;

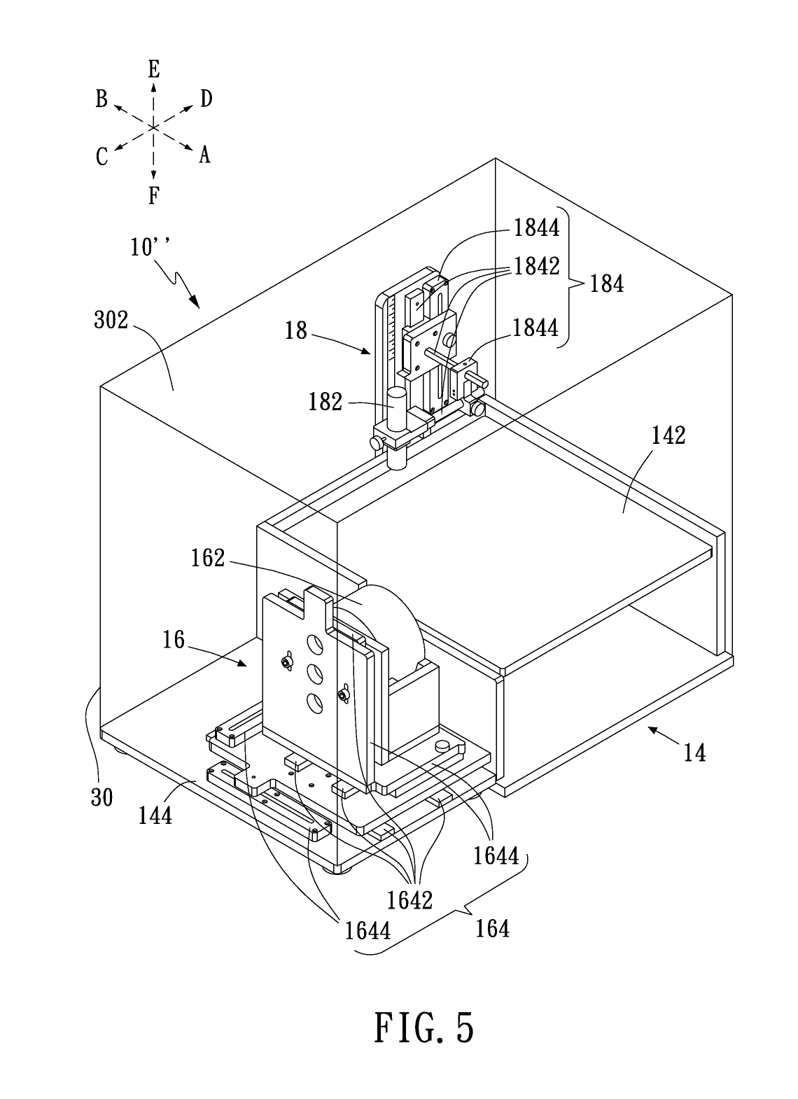

FIG. 5 is a schematic view of the sound quality testing device according to the third embodiment of the present invention; and

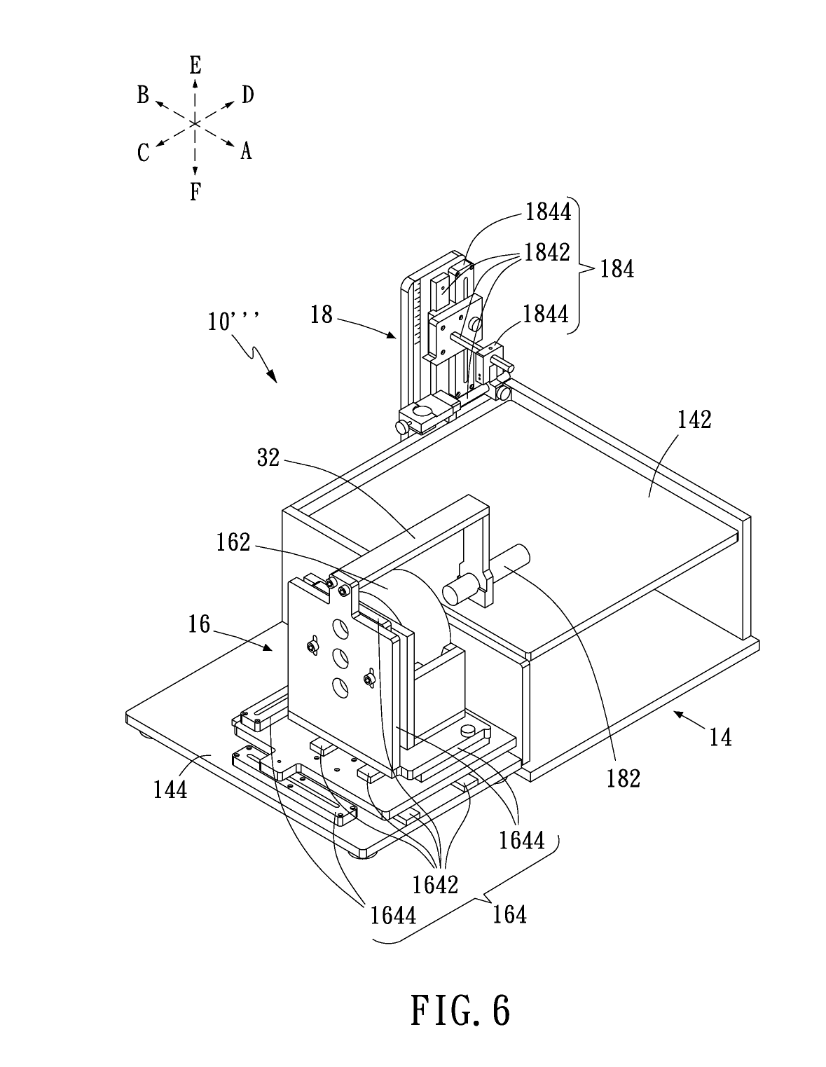

FIG. 6 is a schematic view of calibration of the sound quality testing device according to the fourth embodiment of the present invention.

### DETAILED DESCRIPTION

Referring to FIG. 1, there is shown a schematic view of a sound quality testing device 10 according to the first embodiment of the present invention. As shown in FIG. 1, the sound quality testing device 10 tests a communication apparatus 2 shown in FIG. 2. A sound generating unit 22 and a sound receiving unit 24 are disposed inside the communication apparatus 2. For instance, the communication apparatus 2 is a Voice over Internet Protocol (VoIP) whereby hand-free mode communication takes place or a public switched telephone network (PSTN) phone. In the first embodiment, the communication apparatus 2 is exemplified by a Voice over Internet Protocol (VoIP). The sound generating unit 22 is exemplified by a loudspeaker, and the sound receiving unit 24 is exemplified by a microphone.

Referring to FIG. 1 and FIG. 3, the sound quality testing device 10 comprises a carrying unit 14, a first testing module 16, and a second testing module 18. The carrying unit 14 carries the communication apparatus 2. The carrying unit 14 defines an examination platform 142 and a test platform 144. The examination platform 142 and the test platform 144 lie at different levels. Alternatively, in another embodiment, the examination platform 142 and the test platform 144 lie at the same level. In yet another embodiment, the examination platform 142 and the test platform 144 are fastened to a workbench (not shown) on which the communication apparatus 2 is positioned and tested to evaluate the sound quality thereof, so as to enhance the stability of the carrying unit 14.

Referring to FIG. 1, the first testing module 16 has a sound source unit 162 and a first adjusting unit 164. The sound source unit 162 is disposed at the first adjusting unit 164, such that the position of the sound source unit 162 can be adjusted with the first adjusting unit 164. Hence, not only can the sound source unit 162 be fixed in place, but the sound source unit 162 can move. The sound source unit 162 is exemplified by an artificial mouth or a loudspeaker and adapted to generate a sound signal.

The first testing module 16 is disposed above the test platform 144. The first adjusting unit 164 adjusts the position of the sound source unit 162 based on a preset position of the sound receiving unit 24 of the communication apparatus 2, such that the sound source unit 162 can be positioned at the periphery (defined below) of the sound receiving unit 24. Given the aforesaid adjustment, a sound signal generated by the sound source unit 162 can be precisely sent to the sound receiving unit 24 and thereby configured for use in evaluating sound quality by the sound receiving unit 24. The periphery is defined by the distance that separates the sound source unit 162 and the sound receiving unit 24, wherein the distance is subject to dynamic adjustment based on the communication apparatus 2. In an embodiment, the distance ranges between 2 cm and 15 cm, and can be defined as a near-field distance, such that sound quality measured at the near-field distance can be used in inferring sound quality at a far-field distance. For example, the far-field distance ranges between 45 cm and 55 cm.

The first adjusting unit 164 comprises a sliding element 1642 and a fixing element 1644. The sliding element 1642 allows the sound source unit 162 to move relative to the carrying unit 14. For example, the sliding element 1642 comes in the form of a sliding rail. The fixing element 1644 fixes the sound source unit 162 to the carrying unit 14. For example, the fixing element 1644 fixes the sound source unit 162 to a base (not shown). Hence, the sound source unit 162 approaches the sound receiving unit 24 based on the adjustment of the position of the sliding element 1642 relative to the fixing element 1644.

For instance, the sliding element 1642 is exemplified by a sliding rail. The sound source unit 162 moves in direction A, B, C, D, E or F by means of the sliding rail, whereas the first adjusting unit 164 adjusts the distance between the sound source unit 162 and the sound receiving unit 24. In another embodiment, after the sound source unit 162 has got closer to the sound receiving unit 24, the sound source unit 162 can be fastened to the fixing element 1644 with screws, for example.

The aforesaid adjustment of the distance between the sound source unit 162 and the sound receiving unit 24 includes but is not limited to the disclosure contained in the above embodiments and the accompanying drawings. Hence, whatever means of driving the first testing module 16 to move the sound source unit 162 and fix the sound source unit 162 to a position in the vicinity of the sound receiving unit 24 falls within the scope of the present invention.

The second testing module 18 has a receiving unit 182 and a second adjusting unit 184. The receiving unit 182 is disposed at the second adjusting unit 184. The receiving unit 182 can be moved and fixed in place, as the position of the receiving unit 182 can be adjusted by the second adjusting unit 184. The receiving unit 182 is an artificial ear or a microphone for receiving a sound signal from the sound generating unit 22.

The second testing module 18 is disposed at the carrying unit 14. The second adjusting unit 184 adjusts the position of the receiving unit 182 based on the preset position of the sound generating unit 22 of the communication apparatus 2, such that the receiving unit 182 can be positioned at the periphery of the sound generating unit 22 in order to receive a sound-generating signal from the sound generating unit 22 and evaluate the sound quality of the sound-generating signal thus received. The periphery is defined as above.

The second adjusting unit 184 comprises a sliding element 1842 and a fixing element 1844. The sliding element 1842 enables the receiving unit 182 to be moved relative to the carrying unit 14. For example, the sliding element 1842 comes in the form of a sliding rail or a sliding rod. The fixing element 1844 fixes the receiving unit 182 to the carrying unit 14. For example, the fixing element 1844 is a supportive post for use with the receiving unit 182. Hence, the receiving unit 182 approaches the sound generating unit 22 based on the adjustment effectuated by the sliding element 1842 and the fixing element 1844.

For instance, the sliding element 1842 is exemplified by a sliding rail and a sliding rod. For example, the receiving unit 182 moves in direction E or F by means of the sliding rail. For example, the receiving unit 182 moves in direction A, B, C or D by means of the sliding rod, such that the second adjusting unit 184 can adjust the distance between the receiving unit 182 and the sound generating unit 22.

The aforesaid adjustment of the distance between the receiving unit 182 and the sound generating unit 22 includes but is not limited to the disclosure contained in the above embodiments and the accompanying drawings. Hence, whatever means of driving the second testing module 18 to move the receiving unit 182 and fix the receiving unit 182 to a position in the vicinity of the sound generating unit 22 falls within the scope of the present invention.

Referring to FIG. 4, there is shown a schematic view of a sound quality testing device 10′ according to the second embodiment of the present invention. As shown in FIG. 4, like its counterpart in the first embodiment, the sound quality testing device 10′ in the second embodiment comprises the carrying unit 14 having the examination platform 142 and the test platform 144, the first testing module 16, and the second testing module 18. Unlike its counterpart in the first embodiment, the sound quality testing device 10′ in the second embodiment further comprises a positioning portion 26 and a sliding rail unit 28.

The positioning portion 26 is disposed above the examination platform 142 and adapted to enable the communication apparatus 2 to be positioned at the carrying unit 14. For example, the positioning portion comes in the form of at least one of screws, holes, grooves, stoppers, posts, magnets and suckers. In the second embodiment, the positioning portion 26 is exemplified by a plurality of stoppers 262 and a plurality of holes 264. The positioning portion 26 has thereon the holes 264 arranged longitudinally and transversely, and corresponds in shape to the edges of the bottom of the communication apparatus 2; hence, the stoppers 262 can be coupled to the holes 264, respectively, to fix the communication apparatus 2 to the examination platform 142, selectively.

In another embodiment, the positioning portion 26 is modularized to facilitate the replacement thereof according to the type of the communication apparatus 2 in use, so as to suit the communication apparatus 2 under test.

Referring to FIG. 4, the sliding rail unit 28 is disposed between the carrying unit 14 and the positioning portion 26, such that the communication apparatus 2 can move relative to the carrying unit 14 by means of the positioning portion 26.

Referring to FIG. 5, there is shown a schematic view of a sound quality testing device 10″ according to the third embodiment of the present invention. As shown in FIG. 5, like its counterparts in the preceding embodiments, the sound quality testing device 10″ comprises the carrying unit 14, the first testing module 16, and the second testing module 18. Unlike its counterparts in the preceding embodiments, the sound quality testing device 10″ further comprises a casing 30. The casing 30 has a receiving space 302 for receiving or enclosing the carrying unit 14, the first testing module 16, and the second testing module 18 so as to shut out any external noise signal.

Referring to FIG. 6, there is shown a schematic view of calibration of a sound quality testing device 10″′ according to the fourth embodiment of the present invention. As shown in FIG. 6, like its counterparts in the preceding embodiments, the sound quality testing device 10″′ comprises the carrying unit 14, the first testing module 16, and the second testing module 18. Unlike its counterparts in the preceding embodiments, the sound quality testing device 10″′ further comprises a calibrating unit 32 for testing and calibrating the sound source unit 162 and the receiving unit 182 before testing the sound quality of the communication apparatus 2.

The calibrating unit 32 has two ends, one disposed at the first testing module 16, and the other disposed at the receiving unit 182 of the second testing module 18 for separating the receiving unit 182 from the sound source unit 162 by a specific distance. In this regard, the receiving unit 182 receives a sound-generating signal from the sound source unit 162 in order to carry out calibration. The receiving unit 182 is aligned with the center of the sound source unit 162.

Calibration kicks off as soon as a standard sound signal is generated from the sound source unit 162 and received by the receiving unit 182; meanwhile, the receiving unit 182 receives a test result and analyzes the test result so as to determine whether to calibrate the receiving unit 182. For instance, assuming that the sound source unit 162 generates a standard sound signal of 90 dB, such that the intensity of the sound signal separated from the sound source unit 162 by a distance of 10 cm attenuates to 70 dB (given that sound intensity is inversely proportional to the square of distance), and thus the receiving unit 182 separated from the sound source unit 162 by a distance of 10 cm receives the sound signal of 70 B. However, in the situation where a receiving unit breaks down and needs to be replaced or where a test line has two or more sound quality testing devices for performing a sound quality test concurrently, it is necessary to calibrate the test results yielded by the sound quality testing devices. It is because errors are inherent to every receiving unit manufactured and delivered, and thus test results eventually yielded by the receiving units which have received the standard sound signal under the same condition are not necessarily the same. Hence, it is necessary to calibrate a test result according to the difference between the test result and the standard sound signal.

The present invention provides a sound quality testing device whereby a sound signal is generated by a first testing module and sent to a sound receiving unit (such as a microphone) of a communication apparatus for evaluating the sound quality, such as volume, frequency responses, and harmonic wave distortion, of the sound receiving unit, and then a second testing module receives a sound-generating signal from the sound generating unit, such as a loudspeaker, of the communication apparatus. Accordingly, the present invention features at least two testing modules for simulating an environment in which users operate the communication apparatus, such that the first testing module and the second testing module fetch parameters related to the sound quality of the communication apparatus precisely and quickly.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A sound quality testing device for testing a communication apparatus having a sound generating unit and a sound receiving unit, comprising:
a carrying unit for carrying the communication apparatus;
a first testing module disposed at the carrying unit and having a sound source unit and a first adjusting unit, the sound source unit generating a sound signal, and the first adjusting unit adjusting a position of the sound source unit based on a position of the sound receiving unit of the communication apparatus; and
a second testing module disposed at the carrying unit and having a receiving unit and a second adjusting unit, the receiving unit receiving a sound-generating signal from the sound generating unit, and the second adjusting unit adjusting a position of the receiving unit based on a position of the sound generating unit of the communication apparatus.

2. The sound quality testing device of claim 1, wherein the sound source unit is an artificial mouth or a loudspeaker, and the receiving unit is an artificial ear or a microphone.

3. The sound quality testing device of claim 2, wherein the carrying unit further comprises a positioning portion for positioning the communication apparatus.

4. The sound quality testing device of claim 3, wherein the positioning portion is at least one of screws, holes, grooves, stoppers, posts, magnets, and suckers.

5. The sound quality testing device of claim 4, wherein the holes are arranged longitudinally and transversely, correspond in shape to edges of a bottom of the communication apparatus, and are coupled to the stoppers, respectively, so as to fix the communication apparatus to the carrying unit.

6. The sound quality testing device of claim 3, wherein the positioning portion is modularized to facilitate replacement of the positioning portion based on a type of the communication apparatus.

7. The sound quality testing device of claim 3, further comprising a sliding rail disposed between the carrying unit and the positioning portion for allowing the positioning portion to move relative to the carrying unit.

8. The sound quality testing device of claim 1, wherein the first adjusting unit further comprises a sliding element and a fixing element, the sliding element allowing the sound source unit to move relative to the carrying unit, and the fixing element allowing the sound source unit to be fixed to the carrying unit, so as to adjust a position of the sound source unit.

9. The sound quality testing device of claim 1, wherein the second adjusting unit further comprises a sliding element and a fixing element, the sliding element allowing the receiving unit to move relative to the carrying unit, and the fixing element allowing the receiving unit to be fixed to the carrying unit, so as to adjust a position of the receiving unit.

10. The sound quality testing device of claim 1, further comprising a casing having therein a receiving space for receiving or enclosing the carrying unit, the first testing module, and the second testing module to shut out an external noise signal.

11. The sound quality testing device of claim 1, further comprising a calibrating unit disposed at the first testing module to calibrate the sound source unit.
